(19) United States
(12) Patent Application Publication
(10) Pub. No.: US 2015/0308540 A1
(43) Pub. Date: Oct. 29, 2015

(54) Torsional Vibration Damping Arrangement For Said Powertrain Of A Vehicle

(71) Applicant: ZF FRIEDRICHSHAFEN AG, Friedrichshafen (DE)

(72) Inventors: Daniel Lorenz, Bad Kissingen (DE); Cora Carlson, Dittelbrunn (DE); Ingrid Hoffelner, Knetzgau (DE); Tobias HÖCHE, Hofheim i. UFr. (DE)

(21) Appl. No.: 14/433,898

(22) PCT Filed: Sep. 23, 2013
(86) PCT No.: PCT/EP2013/069740

§ 371 Date: Apr. 7, 2015

(30) Foreign Application Priority Data
Oct. 15, 2012 (DE) 10 2012 218 729.4

(51) Int. Cl. F16F 15/131; F16D 3/66; F16F 15/134

(52) U.S. Cl. CPC F16F 15/13157; F16F 15/13469; F16D 3/66; F16D 2300/06

(57) ABSTRACT

A torsional vibration damping arrangement (10) for the drivetrain of a vehicle comprises an input region (50) to be driven in rotation around an axis of rotation A and an output region (55), and a first torque transmission path (47) and parallel thereto a second torque transmission path (48) which proceed from the input region, and a coupling arrangement (41) for superposing the torques guided via the two torque transmission paths, which coupling arrangement (41) communicates with the output region, and a phase shifter arrangement (43) for the first torque transmission path for generating a phase shift of rotational irregularities guided via the first torque transmission path relative to rotational irregularities guided via the second torque transmission path. The phase shifter arrangement comprises at least one spring set (40) with a curved spring (90).

### PRIORITY CLAIM

This is a U.S. national stage of application No. PCT/EP2013/069740, filed on Sep. 23, 2014. Priority is claimed on the following application: Country: Germany, Application No.: 10 2012 218 729.4, Filed: Oct. 15, 2012, the content of which is incorporated herein by reference in its entirety.

### FIELD OF THE INVENTION

The present invention is directed to a torsional vibration damping arrangement for the drivetrain of a vehicle, comprising an input region which is to be driven in rotation around an axis of rotation and an output region, wherein there are provided between the input region and the output region a first torque transmission path and parallel thereto a second torque transmission path and a coupling arrangement for superposing the torques guided via the torque transmission paths, wherein a phase shifter arrangement is provided in the first torque transmission path for generating a phase shift of rotational irregularities guided via the first torque transmission path relative to rotational irregularities guided via the second torque transmission path.

### BACKGROUND OF THE INVENTION

A generic torsional vibration damping arrangement known from US2013/068580 divides the torque introduced into an input region, for example, through a crankshaft of a drive unit, into a torque component transmitted via a first torque transmission path and a torque component guided via a second torque transmission path. Not only is there a static torque divided in this torque division, but the vibrations and rotational irregularities which are generated, for example, by the periodically occurring ignitions in a drive unit and which are contained in the torque to be transmitted are also divided proportionately into the two torque transmission paths. The torque components transmitted via the two torque transmission paths are brought together again in a coupling arrangement and are then introduced as a total torque into the output region, for example, a friction clutch or the like.

A phase shifter arrangement is provided in at least one of the torque transmission paths. This phase shifter arrangement is constructed in the manner of a vibration damper, i.e., has a primary side and a secondary side which is rotatable with respect to the primary side through the compressibility of a spring arrangement. In particular when this vibration system passes into a supercritical state, i.e., when it is excited with vibrations exceeding the resonant frequency of the vibration system, a phase shift of up to 180° occurs. This means that at maximum phase displacement the vibration components proceeding from the vibration system are shifted in phase by 180° with respect to the vibration components received by the vibration system. Since the vibration components guided via the other torque transmission path do not undergo a phase shift or, if so, a different phase shift, the vibration components which are contained in the unified torque components and which are then shifted in phase with respect to one another are destructively superposed on one another such that, ideally, the total torque introduced into the output region is a static torque which contains essentially no vibration components.

### BACKGROUND OF THE INVENTION

Proceeding from the background art cited above, it is an object of the present invention to further develop a torsional vibration damping arrangement in such a way that it has a further improved vibration damping behavior and is manufactured in an economical manner.

According to the invention, this object is met through a torsional vibration damping arrangement for the drivetrain of a vehicle, comprising an input region to be driven in rotation around an axis of rotation A and an output region, wherein there are provided between the input region and the output region a first torque transmission path and parallel thereto a second torque transmission path, and a coupling arrangement communicating with the output region for superposing the torques guided via the torque transmission paths, and wherein a phase shifter arrangement is provided in the first torque transmission path for generating a phase shift of rotational irregularities guided via the first torque transmission path relative to rotational irregularities guided via the second torque transmission path. The phase shifter arrangement is formed of at least one spring set comprising a curved spring. This spring set may also be referred to as an outer spring set. Often, an additional spring set is used in addition to the outer spring set or in place of the outer spring set. When the two spring sets are arranged radially, this additional spring set may also be referred to as inner spring set. These spring sets can be arranged so as to operate in parallel or in series. The inner spring set can also be constructed with a curved spring. By utilizing curved springs in the outer spring set and/or in the inner spring set, the total amount of spring energy that can be stored with the installation space remaining the same is increased in contrast to a construction with straight spring elements and sliding blocks disposed therebetween. Further, the use of curved springs allows a softer transition in a spring characteristic because sliding blocks can no longer come into collision with one another upon application of torque, since there are no longer any sliding blocks between individual short, straight coil springs. Acceleration peaks during a compression of the spring sets can be prevented in this way with advantageous results for the functioning of the phase shifter arrangement. Further, the use of a curved spring is economical because at least the sliding blocks are dispensed with. Curved springs can preferably be applied in the same configuration as that which is also already employed in dual mass flywheels.

A primary mass of the torsional vibration damping arrangement can be connected, e.g., to an output of a drive unit, formed in this case by a crankshaft, so as to be fixed with respect to rotation relative to it and to a control plate likewise so as to be fixed with respect to rotation relative to it. In this way, the primary mass also forms a planet gear carrier to which a stepped or non-stepped planet gear of the coupling arrangement is rotatably fastened by a planet gear bolt. Together with the planet gears, these components constitute a primary side of the torsional vibration damping arrangement. This fastening of the coupling arrangement to the primary mass is regarded as particularly advantageous in view of a stiff connection, accurate functioning, economical manufacture and a small number of parts.

When the torque runs in axial direction around the axis of rotation A from the input region to the output region, the inner spring set is acted upon in the first torque transmission path via the primary mass and the control plate by a first torque which proceeds from the output of a drive unit formed in this instance by the crankshaft, for example. The first torque proceeds from the inner spring set to the outer spring set via a control disk. From the outer spring set, the first torque is received by a hub disk. The hub disk is connected to an intermediate element so as to be fixed with respect to rotation relative to it, preferably by means of a rivet connection formed in this instance by a rivet bolt, this intermediate element being connected to a driving ring gear so as to be fixed with respect to rotation relative to it. The rivet bolt is guided through an elongated hole in the control disk. This allows the control disk and the hub disk to rotate relative to one another around the axis of rotation A. Consequently, the first torque reaches the driving ring gear via the hub disk and intermediate element. The driving ring gear meshes with the stepped or non-stepped planet gear and accordingly guides the first torque to the stepped or non-stepped planet gear.

In the second torque transmission path, the second torque reaches the planet gear, which may or may not be stepped, directly via the primary mass and a planet gear bolt. The first torque and second torque are guided together again at this planet gear. By means of a driven ring gear, the torque can be conveyed further via an intermediate plate and a secondary flywheel which is connected to the latter so as to be fixed with respect to rotation relative to it. The secondary flywheel forms the output region of the torsional vibration damping arrangement. From that point onward, the torque can be conveyed further to a friction clutch, a converter or the like.

An inner region which may also be referred to as wet region of the torsional vibration damping arrangement contains the phase shifter arrangement and the coupling arrangement. The wet space can be bounded outwardly by the primary mass and a shaping cover plate. Sealing is preferably carried out by means of sealing elements in the radially inner region around the axis of rotation A in order to achieve reduced friction at the sealing elements. The sealing elements can preferably be positioned between a seal adapter, which is connected to the shaping cover plate so as to be fixed with respect to rotation relative to it, and the secondary flywheel and between a connection plate, which is connected to the intermediate plate so as to be fixed with respect to rotation relative to it, and an adapter which is connected to the primary mass so as to be fixed with respect to rotation relative to it.

The positioning of the sealing elements can preferably be selected such that the torsional vibration damping arrangement can be screwed, e.g., to the crankshaft of the drive unit, through a through-hole on the radially inner side. This is advantageous with respect to mounting the torsional vibration damping arrangement at the drive unit.

The wet space can preferably be filled with a lubricant such as oil or grease in order to minimize wear and friction.

In an advantageous embodiment, the coupling arrangement comprises a first input portion and a second input portion into which torques guided via the first torque transmission path and second torque transmission path are introduced, and a superposition unit in which the introduced torques are combined again, and an output portion which conveys the combined torque, for example, to a friction clutch. The first input portion is connected in operative direction thereof to the phase shifter arrangement on one side and to the superposition unit on the other side. The second input portion is connected in operative direction thereof to the input region on one side and to the superposition unit on the other side. The superposition unit is in turn connected in operative direction thereof to both the first input portion and second input portion on one side and to the output portion on the other side. The output portion forms the output region and can receive a friction clutch in an advantageous embodiment.

In order to achieve the phase shift in a simple manner in one of the torque transmission paths, it is suggested that the phase shifter arrangement comprises a vibration system with a primary mass and a secondary mass which is rotatable with respect to the primary mass around the axis of rotation A against the action of a spring arrangement. A vibration system of this type can be constructed as a kind of vibration damper, known per se, in which the resonant frequency of the vibration system can be adjusted in a defined manner, particularly by influencing the primary-side mass and secondary-side mass as well as the stiffness of the spring arrangement, and the frequency at which there is a transition to the supercritical state can accordingly also be determined.

In a further advantageous embodiment of the torsional vibration damping arrangement, the phase shifter arrangement can comprise at least one outer spring set and/or at least one inner spring set. The outer spring set and the inner spring set can be positioned so as to operate in parallel or in series.

In a further favorable embodiment, the outer spring set and/or the inner spring set can comprise a curved spring. The phase shifter arrangement can advantageously be adapted to a corresponding application through a combination of curved springs and, for example, a straight coil spring or by utilizing only curved springs. This means that the phase shifter arrangement can cover a broader spectrum of applications. Further, by employing curved springs, the spring energy to be stored can be increased with the installation space remaining the same in contrast to a construction with short, straight coil springs and sliding blocks or spring disks. Since no sliding blocks or spring disks which can strike one another during a corresponding torque are used when the curved springs are used, acceleration peaks in the spring characteristic which can occur due to sliding blocks or spring disks colliding with one another can be avoided. Therefore, the spring characteristic can be softer without sharp jumps when curved springs are used.

It is provided in a further favorable embodiment that the outer spring set and the inner spring set are positioned radially with respect to one another around the axis of rotation A and, in so doing, at least partially axially overlap with one another and that the outer spring set and the inner spring set are arranged according to a series connection. This arrangement of the spring sets is particularly advantageous when the goal is to reduce the axial installation space. Because of the radial arrangement of the outer spring set and the inner spring set, different centrifugal forces act on the spring sets with the speed staying the same. This can result in a change in friction on the curved springs. This can be advantageous for the design of the spring sets. The series connection of the spring sets can be particularly advantageous for a design when a spring characteristic with different pitches is wanted.

A further favorable embodiment provides that the outer spring set and the inner spring set are positioned radially with respect to one another around the axis of rotation A and, in so doing, at least partially axially overlap with one another and that the outer spring set and the inner spring set are arranged according to a parallel connection. This also results in the advantage in technical respects with regards to the installation space already described above. The spring stiffness can be increased with the spring deflection remaining the same by a parallel connection of the outer spring set and inner spring set.

A further advantageous embodiment provides that the phase shifter arrangement and the coupling arrangement are at least partially received in a wet space which is at least partially filled with a fluid. The wet space at least partially comprises an inner region of the torsional vibration damping arrangement. The wet space can be bounded outwardly by at least one element forming a housing portion, e.g., the primary mass and a cover plate on the transmission side. Sealing is preferably effected by means of sealing elements in the radially inner region around the axis of rotation A in order to achieve reduced friction at the sealing elements caused by elements which are rotatable relative to the latter. The sealing elements can preferably be positioned between the transmission-side cover plate and the secondary flywheel and between an intermediate flange and the adapter. The positioning of the sealing elements can preferably be selected such that the torsional vibration damping arrangement can be screwed, e.g., to the crankshaft of the drive unit, through a through-hole radially inside of the sealing elements by means of at least one crankshaft screw. This is advantageous with respect to mounting the torsional vibration damping arrangement at the drive unit. The wet space can preferably be filled at least partially with a lubricant such as oil or grease in order to minimize wear and friction.

In a further advantageous embodiment, the coupling arrangement comprises a summing gear unit. The first torque running along the first torque transmission path and the second torque running along the second torque transmission path are guided together in this summing gear unit and are conducted to the output region.

In a further embodiment with respect to the embodiment mentioned above, the summing gear unit can advantageously be constructed as a planetary gear unit. The planetary gear unit can comprise a planet gear, a planet gear bolt and a driving ring gear and driven ring gear. The planet gear bolt can advantageously be connected to the primary mass so as to be fixed with respect to rotation relative to it, which primary mass forms the planet gear carrier. However, in a further embodiment the planet gear bolt can also be connected to a planet gear carrier so as to be fixed with respect to rotation relative to it, which planet gear carrier is arranged as a separate component part in addition to the primary mass. The primary mass and the separate planet gear carrier are connected to the output of the drive unit so as to be fixed with respect to rotation relative to it. The planet gear, which may or may not be stepped, is rotatably mounted on the planet gear bolt. The first torque can be conducted to the planet gear, for example, via the primary mass and the phase shifter arrangement, by means of the driving ring gear. The second torque can be conducted directly from the primary mass or via the separate planet gear carrier into the planet gear bolt and further to the planet gear. The first torque and the second torque are guided together again at the planet gear and supplied by the driven ring gear to the output region to which, for example, a friction clutch or a converter or a similar component part can be fastened.

In an advantageous embodiment of the torsional vibration damping arrangement with respect to the previous embodiments, with respect to a torque running in axial direction from the input region to the output region, the coupling arrangement can be arranged downstream of the phase shifter arrangement in this axial direction. A stiff connection of the phase shifter arrangement and, therefore, a good adjustability of the spring sets in the phase shifter arrangement can be achieved by the direct rotationally locked connection of the primary mass of the phase shifter arrangement to the input region which can be formed, for example, by the crankshaft. The course of the first torque transmission path is considered advantageous in this arrangement because it leads from the input region via the phase shifter and further via an intermediate element into the coupling arrangement and, from the latter, into the output region.

In an embodiment of the torsional vibration damping arrangement which is an alternative to that described above and which is likewise advantageous, with respect to a torque running in axial direction from the input region to the output region, the phase shifter arrangement can be arranged downstream of the coupling arrangement in this axial direction. This arrangement makes possible a direct and therefore stiff connection of the coupling arrangement to the input region, which is regarded as very advantageous with respect to the functioning of the coupling arrangement. However, the torque component which runs through the phase shifter arrangement must first be guided past the upstream coupling arrangement. Accordingly, the connection of the phase shifter arrangement to the input region is less stiff. This can be advantageous depending on the layout of the vibration system.

In a further advantageous embodiment, the intermediate element can receive an additional mass. As a result of this additional intermediate mass at the intermediate element, the mass moment of inertia is increased in this region. Accordingly, the decoupling can be improved by adapting a gear ratio of the coupling gear unit and the spring characteristic, particularly at low speeds.

### BRIEF DESCRIPTION OF THE DRAWINGS

Preferred embodiment of the invention will be described in the following with reference to the accompanying drawings in which:

FIG. 1A shows a torsional vibration damping arrangement with an outer spring set and an inner spring set, both of which are constructed in this instance with curved springs, wherein the outer spring set has a smaller diameter than the inner spring set;

FIG. 1B shows a side view of an exemplary curved spring;

FIG. 2 shows a torsional vibration damping arrangement with an outer spring set and an inner spring set, wherein the outer spring set has a smaller diameter than the inner spring set;

FIG. 3 shows a torsional vibration damping arrangement with an outer spring set and an inner spring set, wherein the inner spring set has a smaller spring diameter than the outer spring set;

FIG. 4 shows a torsional vibration damping arrangement with an outer spring set and an inner spring set, wherein the inner spring set and the outer spring set have an identical spring diameter, and with an additional mass at an intermediate element;

FIG. 5 shows a torsional vibration damping arrangement with an additional intermediate mass at a driving ring gear carrier; and

FIG. 6 shows a torsional vibration damping arrangement with an outer spring set and an inner spring set, wherein the inner spring set has a smaller spring diameter than the outer spring set.

### DETAILED DESCRIPTION OF THE PRESENTLY PREFERRED EMBODIMENTS

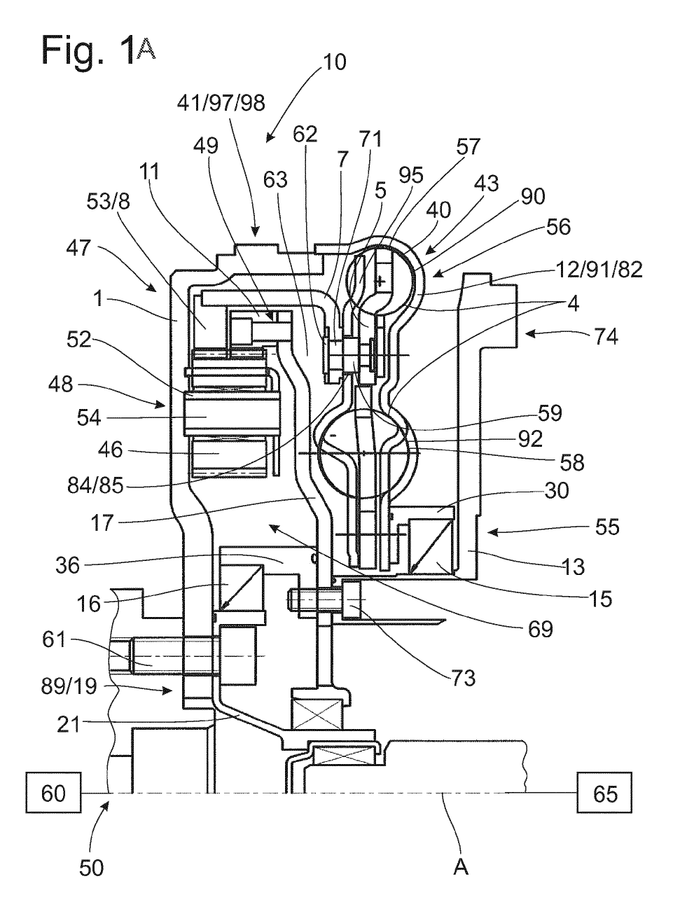

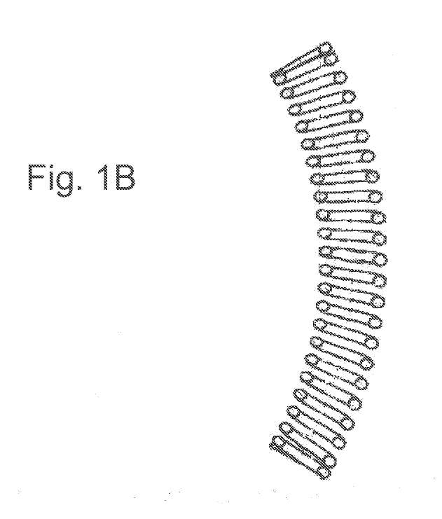

FIG. 1A shows a torsional vibration damping arrangement 10 which operates on the principle of power splitting or torque splitting. The torsional vibration damping arrangement 10 can be arranged in a drivetrain of a vehicle between a drive unit 60 and the subsequent portion of the drivetrain, i.e., for example, a start-up element 65 such as a friction clutch, a hydrodynamic torque converter, or the like.

The torsional vibration damping arrangement 10 comprises an input region, designated generally by 50. This input region 50 can be connected, for example by a screw connection 61, to an output of a drive unit 89 which is formed in this instance by a crankshaft 19. In the input region 50, the torque received from the drive unit 60 branches into a first torque transmission path 47 and a second torque transmission path 48. In the region of a coupling arrangement, designated generally by reference numeral 41, the torque components guided via the two torque transmission paths 47, 48 are introduced into the coupling arrangement 41 by means of a first input portion 53 and a second input portion 54 and are combined again therein. The torque is guided to a secondary flywheel 13 via an output portion 49, constructed in this instance as a driven ring gear 11, and an intermediate plate 17 which are connected to one another so as to be fixed with respect to rotation relative to one another, this secondary flywheel 13 being connected to the intermediate plate 17 so as to be fixed with respect to rotation relative to it. The secondary flywheel 13 can form the output region 55.

A vibration system, designated generally by reference numeral 56, is integrated in the first torque transmission path 47. The vibration system 56 acts as a phase shifter arrangement 43 and comprises a primary mass 1 which is to be connected, for example, to the drive unit 60. The primary mass 1 is connected to a shaping cover plate 91 so as to be fixed with respect to rotation relative to it. In this instance, this shaping cover plate 91 also forms a control plate 82 for an outer spring set 57. The use of the shaping cover plate 91 is to be viewed as an economical embodiment, since the shaping cover plate 91 can be shaped by means of a shaping process such as pressing. Further, the shaping cover plate 91 guides an inner spring set 58 and the outer spring set 57 in radial and axial direction and controls the inner spring set 58 through an integrally formed control nose. The vibration system 56 comprises the outer spring set 57 and/or the inner spring set 58 which are arranged radially with respect to one another with reference to the axis of rotation A and operate serially. In an embodiment which is not shown, the spring sets can also be arranged so as to operate in parallel.

The outer spring set 57 and/or the inner spring set 58 comprise or comprises spring elements which are constructed at least with one curved spring 90 and 92 as shown in FIG. 1B. Advantages can be achieved through the use of the curved springs with regard to a storage of an achievable spring energy in contrast to a use of a short, straight coil spring which is guided in a sliding block. Corresponding to an occurring torque value, it can come about through use of a plurality of short, straight coil springs and sliding blocks that some sliding blocks collide with one another so that acceleration peaks occur in a recorded spring characteristic. These acceleration peaks are disadvantageous for an accurate functioning of the phase shifter arrangement 43. These acceleration peaks can be prevented through the use of the curved springs 90 and/or 92.

The inner spring set 58 is supported with respect to operation thereof at the control plate 82 on the one hand and at a control disk 95 on the other hand. The outer spring set 57 is supported at the aforementioned control disk 95 on the one hand and at a hub disk 5 on the other hand. Between the outer spring set 57 and the inner spring set 58, the control disk 95 has a clearance bore 84 which runs in direction of the axis of rotation A and which is constructed as an elongated hole 85 running radially around the axis of rotation A and through which a rivet bolt 59 is guided. An intermediate element 7 is received between a rivet head 62 of the rivet bolt 59 and the control disk 95 such that the intermediate element 7 is connected to the rivet bolt 59 so as to be fixed with respect to rotation relative to it and is rotatable in the elongated hole 85 around the axis of rotation A relative to the control disk 95. The intermediate element 7 receives a driving ring gear 8 so as to be fixed with respect to rotation relative to it, this driving ring gear 8 being in operative connection with a stepped or non-stepped planet gear 46.

A radially inner region of the shaping cover plate 91 can be connected to a seal adapter 30 so as to be fixed with respect to rotation relative to it, which seal adapter 30 receives a sealing element 15 for sealing a wet space 63 relative to a dry space 74. The sealing element 15 is positioned between the seal adapter 30 and the secondary flywheel 13 which is rotatable relative to the latter. The sealing element 15 can advantageously be a radial shaft seal ring with one or more sealing lips which seal in one or both directions and which are constructed of one material or different materials in a pre-loaded or non-pre-loaded configuration. The primary mass 1 and the shaping cover plate 91 substantially completely surround radially outwardly a space area 69 in which the phase shifter arrangement 43 and coupling arrangement 41 can be contained with respect to a radial enclosure. The wet space 63 is sealed relative to the dry space 74 by a further sealing element 16. In this case, the sealing element 16 is positioned between an adapter 21, which is fastened, preferably by screwing 36, to the primary mass 1 so as to be fixed with respect to rotation relative to it, and a connection plate 36 which is connected, preferably by a screw connection 73, to the intermediate plate so as to be fixed with respect to rotation relative to it. The adapter 21 and the connection plate 36 can rotate relative to one another. The sealing element 16 can be constructed as a radial shaft seal, for example.

The coupling arrangement 41 is positioned in the second torque transmission path 48. In this case, the coupling arrangement 41 is formed of the stepped or non-stepped planet gear which is rotatably supported at the primary mass 1 by a planet gear bolt 52. Fastening directly to the primary mass 1 is a stiff embodiment variant and is regarded as particularly advantageous for an accurate functioning of the coupling arrangement 41.

A torque in the first torque transmission path 47 can proceed from the crankshaft 19 via the primary mass 1 and the control plate 82 into the inner spring set 58. The first torque is guided from the inner spring set 58 to the outer spring set 57 via the control disk 95. From the outer spring set 57, the first torque arrives at the stepped or non-stepped planet gear 46 of the coupling arrangement 41 via the hub disk 5, the rivet bolt 59, the intermediate element 7 and the driving ring gear 8.

A torque in the second torque transmission path 48 runs from the crankshaft 19 via the primary mass 1 and the planet gear bolt 52 into the stepped or non-stepped planet gear 46.

Accordingly, the first torque transmission path 47 and the second torque transmission path 48 meet at the planet gear 46 and are guided together at the latter. The combined torque passes from the planet gear 46 via a driven ring gear 11 into an intermediate plate 17 and from the latter into a secondary flywheel 13. In this case, the combined torque can be delivered, for example, to a clutch which is to be flanged or to a torque converter.

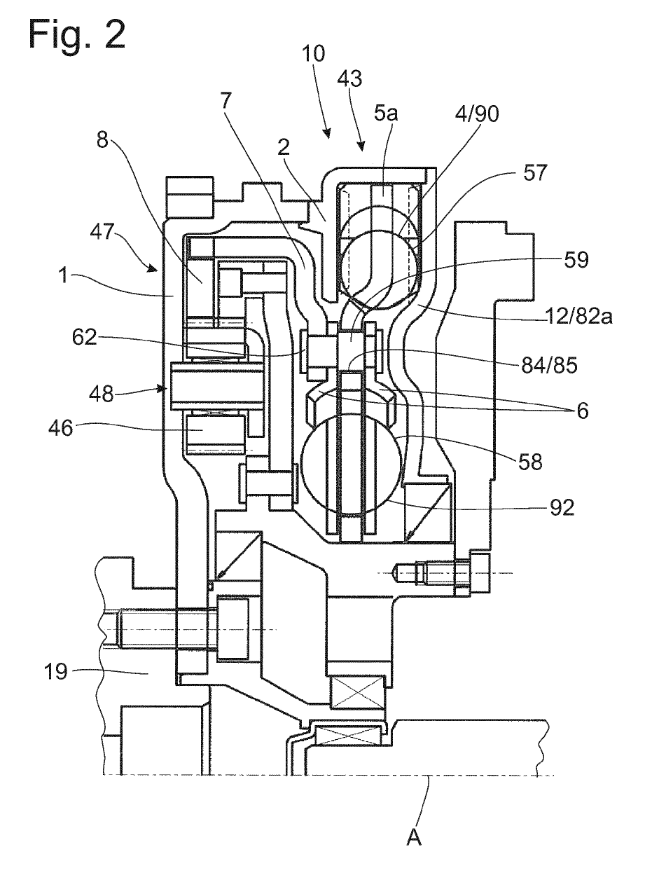

FIG. 2 shows a torsional vibration damping arrangement 10 like that shown in FIG. 1 but with an altered torque path within the phase shifter arrangement 43. As is also described with reference to FIG. 1, the phase shifter arrangement comprises an outer spring set 57 and an inner spring set 58 which are arranged one behind the other radially around the axis of rotation A and operate in series. The inner spring set 58 is radially upstream of the outer spring set 57. In contrast to FIG. 1, however, the outer spring set 57 is controlled by a control plate 82a initially in the first torque transmission path 47, which control plate 82a is connected to a center cover plate 2 so as to be fixed with respect to rotation relative to it. The center cover plate 2 is connected to a primary mass 1 so as to be fixed with respect to rotation relative to it. A first torque in the first torque transmission path 47 can run in the phase shifter arrangement 43 as described in the following.

The outer spring set 57 is supported on the one hand at the control plate 82 which can be formed by a transmission-side cover plate 12 and on the other hand at a hub disk 5a formed as center disk. The inner spring set 58 is supported on one side at the above-mentioned hub disk 5a and on the other side at at least one cover plate 6. Between the outer spring set 57 and inner spring set 58, the hub disk 5 comprises a clearance bore 84 which runs in direction of the axis of rotation A and is constructed as an elongated hole 85 running radially around the axis of rotation A and through which a rivet bolt 59 is guided. The cover plate 6 is received between a rivet head 62 of the rivet bolt 59 and the hub disk 5a such that the cover plate 6 is connected to the rivet bolt 59 so as to be fixed with respect to rotation relative to it and is rotatable in the elongated hole 85 around the axis of rotation A relative to the hub disk 5a. At the rivet bolt 59, an intermediate element 7 is connected on one side to the rivet bolt 59 so as to be fixed with respect to rotation relative to it at the side facing the coupling arrangement 41. The intermediate element 7 receives the driving ring gear 8 so as to be fixed with respect to rotation relative to it, this driving ring gear 8 being in operative connection with a planet gear 46.

In the first torque transmission path 47, a first torque proceeding from the crankshaft 19 can run into the outer spring set 57 via the primary mass 1, the center cover plate 2 and the control plate 82. From the outer spring set 57, the first torque is guided via the hub disk 5a to the inner spring set 58. From the inner spring set 58, the first torque arrives at the stepped or non-stepped planet gear 46 via at least one cover plate 6, which is positioned between the outer spring set 57 and the inner spring set 58 in radial direction around the axis of rotation A, via the intermediate element 7 and the driving ring gear 8. The positioning of the cover plate 6 between the outer spring set 57 and the inner spring set 58 is advantageous for a compact radial installation space of the torsional vibration damping arrangement 10.

The second torque runs via the second torque transmission path 48 as has already been described referring to FIG. 1.

By utilizing an inner spring set 58 which has a larger diameter than the outer spring set 57 and which is advantageously constructed in this instance as a curved spring 92, higher spring energy can be stored. Further, the inner spring set 58 works with low friction because it is arranged farther radially inside and is therefore exposed to less centrifugal forces than the outer spring set 57. Accordingly, a softer characteristic of the inner spring set 58 can also be used, which is advantageous when decoupling at a high speed, since the outer spring set 57 contributes only slightly to the decoupling due to the centrifugal force and the friction arising therefrom. As a result of this dimensioning of the inner spring set 58, a very good decoupling can be achieved at low speeds, approximately 500 RPM, by positioning a cancelling point in this range. A good decoupling also results at high speeds, approximately 1200 RPM, due to the inner spring set 58 which continues to work.

It is advantageous with respect to a compact axial installation space and favorable for economizing on weight when the intermediate element 7 which receives the driven ring gear is positioned between the inner spring set 58 and the outer spring set 57.

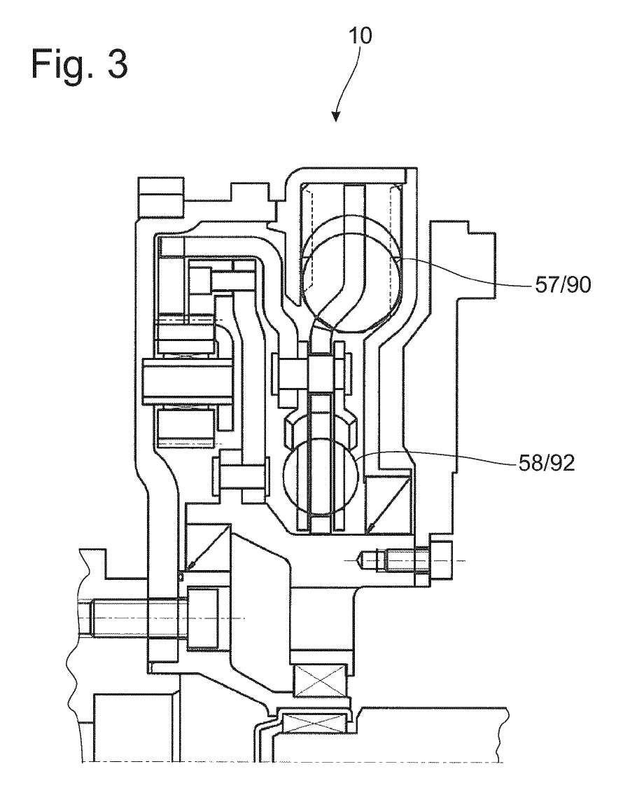

FIG. 3 shows a torsional vibration damping arrangement 10 such as that in FIG. 2, but with an outer spring set 57 having a larger diameter than the inner spring set 58. The outer spring set 57 and/or the inner spring set 58 are/is constructed as a curved spring 90 and/or 92. The larger diameter of the outer spring set 57 is advantageous particularly when the excitations to be damped, for example, a main engine order of 1.5 in three-cylinder engines, have a lower excitation order and large excitation amplitude at the same time. Due to a very low stiffness, the resonant frequency of the phase shifter can be decreased until it is possible to reduce a rotational irregularity at very low speeds. The stiff connection of the planet gears 46 is also advantageous in this case as was described referring to FIGS. 1 and 2.

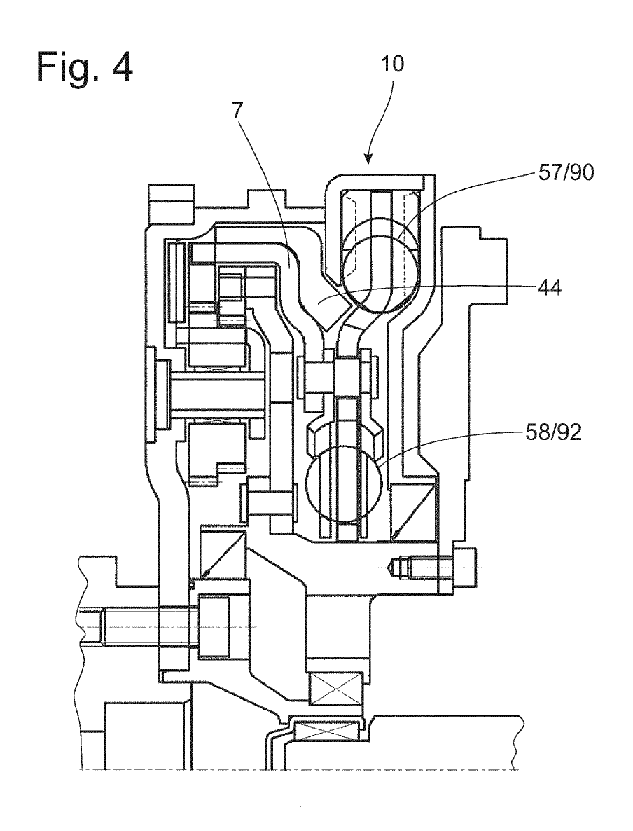

FIG. 4 shows a torsional vibration damping arrangement 10 such as that in FIG. 3, but with an identical diameter for the outer spring set 57 and the inner spring set 58. The outer spring set 57 and/or the inner spring set 58 have/has at least one curved spring 90 and/or 92. Further, an additional mass 44 is arranged at the intermediate element 7. As a result, an increased intermediate mass inertia is achieved. The increased intermediate mass inertia improves decoupling. The stiff connection of the planet gears 46 is also advantageous in this case as was described referring to FIGS. 1 to 3.

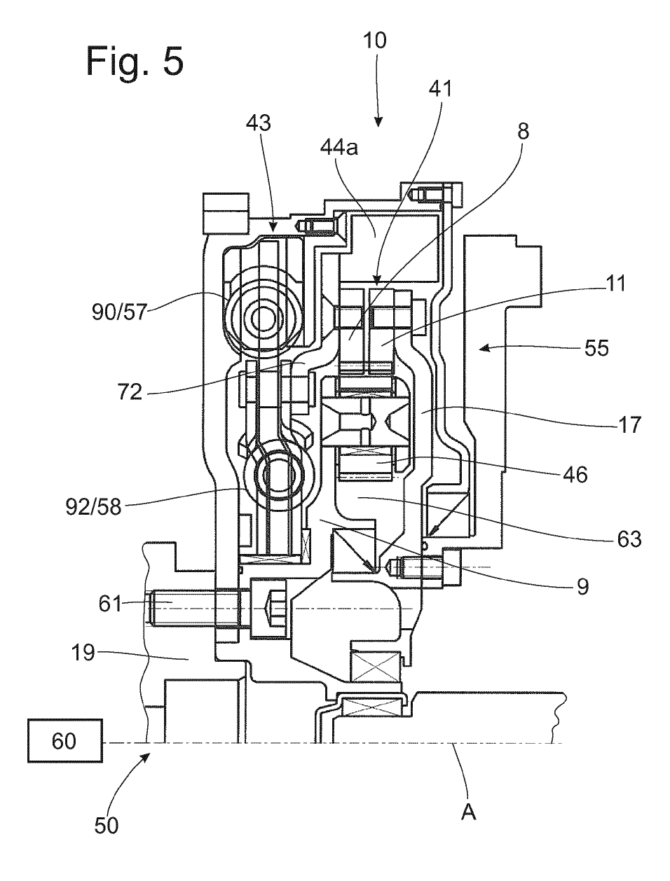

FIG. 5 shows a torsional vibration damping arrangement 10 such as that described referring to FIG. 3, but in this case, in contrast to FIGS. 1 to 4, a phase shifter arrangement 43 is arranged upstream of a coupling arrangement 41 with an axial torque path from an input region 50 to an output region 55. The phase shifter arrangement 43 can comprise an outer spring set 57 and/or an inner spring set 58 which are/is arranged radially successively around the axis of rotation A and work in series. The outer spring set 57 and/or the inner spring set 58 can be constructed as at least one curved spring 90 and 92. In an embodiment which is not shown, the outer spring set 57 and the inner spring set 58 can also operate in parallel. The coupling arrangement 41 is located in radial direction between the outer spring set 57 and the inner spring set 58. The axial position of the coupling arrangement 41 has already been described. Due to the axial arrangement of the coupling arrangement 41, a planet gear carrier 9 cannot be formed by the primary mass 1 as was the case in FIGS. 1 to 4. In this instance, the planet gear carrier 9 is formed as a separate component part which is fastened to the crankshaft 19 so as to be fixed with respect to rotation relative to it on the radially inner side by means of screwing 61 together with the primary mass 1.

Due to a radially compact arrangement of the coupling arrangement 41, which is formed in this instance by a planet gear 46, a driving ring gear 8 with a driving ring gear carrier 72 connected to the latter so as to be fixed with respect to rotation relative to it, and a driven ring gear 11 with an intermediate element 7 connected so as to be fixed with respect to rotation relative to it, the driving ring gear carrier can be constructed with an additional mass 44a. A mass moment of inertia of the driving ring gear carrier 72 can be changed in this way. This is particularly advantageous in case of adaptation of the torsional vibration damping arrangement 10. The additional mass 44a is arranged radially outside of the coupling arrangement 41 and, in so doing, at least partially overlaps the coupling arrangement 41. The additional mass 44a is located inside the torsional vibration damping arrangement 10 in a wet space 63, as it is called, which can be filled with lubricant such as oil or grease.

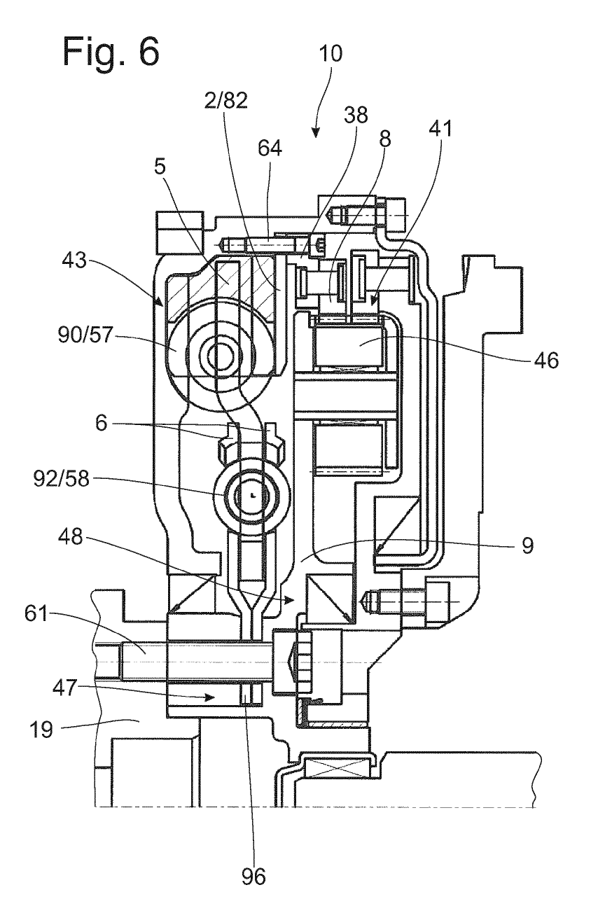

FIG. 6 shows a torsional vibration damping arrangement 10 with a spatial arrangement of the coupling arrangement 41 and phase shifter arrangement 43 such as that shown in FIG. 5, but the path of the first torque in the first torque transmission path 47 through the phase shifter arrangement 43 is different than in FIG. 5. In FIG. 6, the first torque proceeds from the crankshaft 19 into a control plate 96 which is connected to the crankshaft 19, preferably by screwing 61, so as to be fixed with respect to rotation relative to it. At least one cover plate 6 is connected to the control plate 96, preferably by means of a rivet connection, not shown, so as to be fixed with respect to rotation relative to it. In an embodiment which is not shown, the control plate 96 can also comprise the cover plate 6 at the same time. The first torque is guided to an inner spring set 58 from the cover plate 6. The first torque proceeds from the inner spring set 58 to the outer spring set 57 via a hub disk 5. From the outer spring set 57, the first torque is received by a center cover plate 2, which is formed in this instance as a recess nose, not shown, and is conducted to a ring gear carrier 38 which is connected to the center cover plate 2 so as to be fixed with respect to rotation relative to it, preferably by means of a screw connection 64, not shown, but optionally also as a weld connection for reasons of economy. A driving ring gear 8 is connected to the ring gear carrier 38 so as to be fixed with respect to rotation relative to it. The first torque arrives at a planet gear 46 of the coupling arrangement 41 via the driving ring gear 8. Using a curved spring 90 as outer spring set 57 presents an inexpensive alternative, since it obviates the use of sliding blocks or guide blocks which would otherwise be necessary when short, straight coil springs are used. Further, as has already been noted, a higher spring energy can also be stored in this case without having acceleration peaks in a spring characteristic. This would be the case otherwise when using sliding blocks between the short, straight coil springs because these sliding blocks can collide with one another when the individual coil springs are compressed resulting in acceleration peaks.

As is also shown in FIG. 5, the planet gear 46 is rotatably fastened to a separate plant gear carrier 9. The planet gear carrier 9 is fastened on the radially inner side to the crankshaft 19 so as to be fixed with respect to rotation relative to it by screwing 61 together with the control plate 96. In contrast to FIG. 5, a large mass moment of inertia of the intermediate mass inertia is realized in this case because the component parts 7 and 12 together form the intermediate mass in the present constructional embodiment.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A torsional vibration damping arrangement (10) for the drivetrain of a vehicle, comprising:
an input region (50) to be driven in rotation around an axis of rotation (A);
an output region (55);
a first torque transmission path (47) and parallel thereto a second torque transmission path (48), both said first and second torque transmissions paths proceeding from said input region (50);
a coupling arrangement (41) for superposing said torques guided via said torque transmission paths (47; 48), said coupling arrangement (41) communicating with said output region (55);
a phase shifter arrangement (43) for said first torque transmission path (47) for generating a phase shift of rotational irregularities guided via said first torque transmission path (47) relative to rotational irregularities guided via said second torque transmission path (48); said phase shifter arrangement (43) comprising at least one spring set (40) with a curved spring (90).

15. The torsional vibration damping arrangement (10) according to claim 14, wherein said coupling arrangement (41) comprises a first input portion (53), a second input portion (54), a superposition unit (52) and an output portion (49), wherein the first input portion (53) is connected to said phase shifter arrangement (43) and to said superposition unit (52), and the second input portion (54) is connected to said input region (50) and to said superposition unit (52), and said superposition unit (52) is connected to both said first input portion (53) and said second input portion (54) and to said output portion (49), and wherein said output portion (49) forms said output region (55).

16. The torsional vibration damping arrangement (10) according to claim 14, wherein said phase shifter arrangement (43) comprises a vibration system (56) with a primary mass (1) and an intermediate element (7) which is rotatable with respect to the primary mass (1) around the axis of rotation (A) against the action of a spring arrangement (4).

17. The torsional vibration damping arrangement (10) according to claim 14, wherein said phase shifter arrangement (43) comprises at least one of an outer spring set (57) and one inner spring set (58), said inner spring set (58) being arranged at least partially radially inside of said outer spring set (57).

18. The torsional vibration damping arrangement (10) according to claim 14, wherein at least one of said outer spring set (57) and said inner spring set (58) comprises a curved spring (90; 92).

19. The torsional vibration damping arrangement (10) according to claim 14, wherein said outer spring set (57) and said inner spring set (58) are positioned radially with respect to one another around said axis of rotation A so as to at least partially axially overlap with one another, and wherein said outer spring set (57) and said inner spring set (58) are connected in series.

20. The torsional vibration damping arrangement (10) according to claim 14, wherein said outer spring set (57) and said inner spring set (58) are positioned radially with respect to one another around said axis of rotation A so as to at least partially axially overlap with one another, and wherein said outer spring set (57) and said inner spring set (58) are connected in parallel.

21. The torsional vibration damping arrangement (10) according to claim 14, wherein said phase shifter arrangement (43) and said coupling arrangement (41) are at least partially received in a wet space (63), said wet space being at least partially filled with a fluid.

22. The torsional vibration damping arrangement (10) according to claim 14, wherein said coupling arrangement (41) comprises a summing gear unit (97).

23. The torsional vibration damping arrangement (10) according to claim 22, wherein said summing gear unit (97) comprises a planetary gear unit (98) with a planet gear (46), a planet gear bolt (52) and a driving ring gear (8) and a driven ring gear (11).

24. The torsional vibration damping arrangement (10) according to claim 14, wherein, with respect to a torque running in an axial direction from said input region (50) to said output region (55), said coupling arrangement (41) is arranged downstream of said phase shifter arrangement (43).

25. The torsional vibration damping arrangement (10) according to claim 14, wherein, with respect to a torque running in an axial direction from said input region (50) to said output region (55), said phase shifter arrangement (43) is arranged spatially downstream of said coupling arrangement (41).

26. The torsional vibration damping arrangement (10) according to claim 22, additionally comprising an additional mass (44) operatively connected to said intermediate element (7).
